(19) United States
(12) Patent Application Publication
(10) Pub. No.: US 2008/0131851 A1
(43) Pub. Date: Jun. 5, 2008

(54) CONTEXT-SENSITIVE LANGUAGE LEARNING

(76) Inventors: Dimitri Kanevsky, Ossining, NY (US); Peter G. Fairweather, Yorktown Heights, NY (US)

Correspondence Address: William E. Lewis;RYAN, MASON & LEWIS, LLP, 90 Forest Avenue, Locust Valley, NY, 11560, US

(21) Appl. No.: 11/566,463

(22) Filed: Dec. 4, 2006

(51) Int. Cl. G09B 19/06

(52) U.S. Cl. 434/157

(57) ABSTRACT

Techniques for context-sensitive language learning are disclosed. For example, a language learning system may include an interface for communicating with at least one user, at least one sensor for collecting at least one form of data regarding the context in which the system is being used, and a processing device capable of making at least one adjustment to the communication with the user based on analysis of at least a portion of the data collected by the at least one sensor. The data may include audio data, visual information, biometric data, location, or velocity and the sensors may include a microphone, a camera, a biometric sensor, a global positioning system (GPS) device, or a velocimeter. The system may also use this data, alone or in combination with schedule data obtained from an external source, to determine the attention level of the user and to make corresponding adjustments to the communication. The system may further be capable of tracking changes to the data collected by the sensor and/or the number and/or type of errors made by the user and making corresponding adjustments to the communication.

### FIELD OF THE INVENTION

The present invention relates to computer-assisted language learning and, more particularly, to the incorporation of contextual cues in an interactive interface for language learning.

### BACKGROUND OF THE INVENTION

Current techniques for Computer-Assisted Language Learning (CALL) and Technology Enabled Language Learning (TELL) include approaches such as translation and transcription exercises, simulated dialogue, reading in the target language, or reading parallel language texts. Generally speaking, these techniques present some sort of pure or combined audio, graphic, textual, or video stimulus to which the learner is to respond using speech, writing, or menu selections.

However, contemporary linguistics research shows that language learning is strongly facilitated by the use of the target language in interactions where the learner can negotiate the meaning of vocabulary and that the use of words in new contexts stimulates a deeper understanding of their meaning. Current TELL and CALL technologies lack the ability to give the learner an opportunity to linguistically interact within his or her current problem-solving context.

Pocket translators allow users to quickly translate text but do not provide contextual or cultural background. Furthermore, pocket translators are not interactive and do not allow the user to practice a new language in conversational situations. Hand-held translation devices also require the user to provide input for translation which limits the user's ability to interact with their environment if they have to type or speak into a translator. Hand-held translation devices act only as a tool to assist in language learning and have very limited function as an interactive instructional device.

Although museums and exhibitions often provide hand-held translation devices that can utilize user input regarding physical location to translate location-specific content, such technologies do not provide the important conversational aspect that is necessary in learning a new language. These hand-held translation devices are functionally limited within the location involving a specific set of exhibits or demonstrations and require pre-programming of data regarding each location.

While computer-enabled video interactions can present engaging situations that provide opportunities to model and practice language, the most successful of them must resort to dramatic excess to maintain learner engagement. Their focus on rare or contrived situations leads to learners hearing and using unusual or infrequent expressions which would be not be useful in everyday situations. Furthermore, the learner does not link language use to his or her actions and goals; instead, language use relates to the portrayed actors' actions and goals.

### SUMMARY OF THE INVENTION

Principles of the invention provide improved techniques for language acquisition through the incorporation of data concerning the context in which acquisition is occurring.

By way of example, in one aspect of the present invention, a language learning system includes an interface for communicating with at least one user, at least one sensor for collecting at least one form of data regarding the context in which the system is being used, and a processing device capable of making at least one adjustment to the communication with the user based on analysis of at least a portion of the data collected by the at least one sensor.

The data may include audio data, visual information, biometric data, location, or velocity and the sensors may include a microphone, a camera, a biometric sensor, a global positioning system (GPS) device, or a velocimeter. The system may also use this data, alone or in combination with schedule data obtained from an external source, to determine the attention level of the user and to make corresponding adjustments to the communication. The system may further be capable of tracking changes to the data collected by the sensor and/or the number and/or type of errors made by the user and making corresponding adjustments to the communication.

In another aspect of the present invention, a method for facilitating language acquisition includes the steps of collecting at least one form of data regarding the context in which acquisition is occurring and communicating with at least one user wherein the communication is based at least in part on analysis of at least a portion of data collected by at least one sensor.

Advantageously, principles of the invention provide enhanced techniques for utilizing contextual information to facilitate enhanced language acquisition. Principles of the invention provide for incorporating contextual cues into a conversation in order to facilitate deeper understanding of a target language. Principles of the invention also permit adjusting the pace of the conversation in response to the user's attention level and/or errors.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a context-sensitive language learning system and exemplary inputs thereto, according to an embodiment of the invention.

FIG. 2 shows another view of a context-sensitive language learning system and exemplary inputs thereto, according to an embodiment of the invention.

FIG. 3 shows an audio processing module, according to an embodiment of the invention.

FIG. 4 shows a video processing module, according to an embodiment of the invention.

FIG. 5 shows a biometric processing module, according to an embodiment of the invention.

FIG. 6 shows a synchronization module, according to an embodiment of the invention.

FIG. 7 shows a compiler module, according to an embodiment of the invention.

FIG. 8 shows a language teaching processing module, according to an embodiment of the invention.

FIG. 9 is a method for context-sensitive language learning, according to an embodiment of the invention.

FIG. 10 is a block diagram depicting an exemplary processing system 1000 formed in accordance with an aspect of the invention.

### DETAILED DESCRIPTION OF PREFERRED EMBODIMENTS

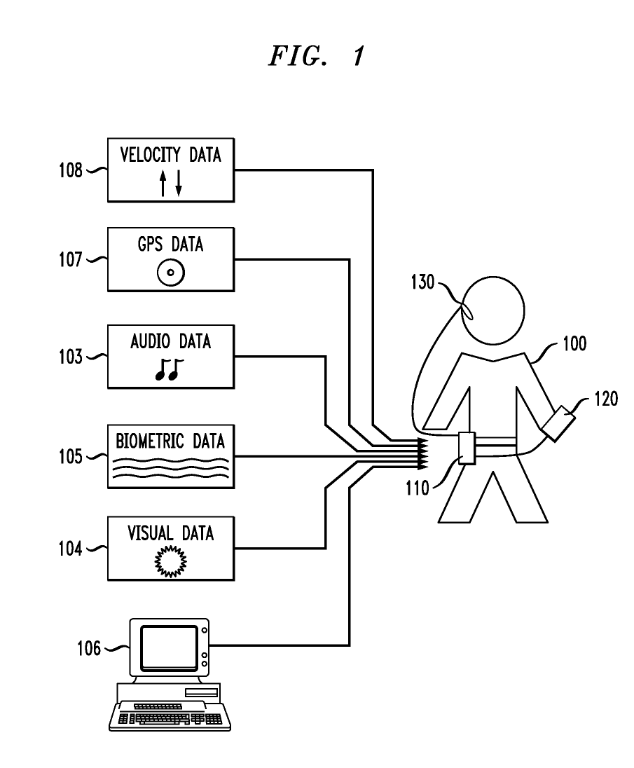

FIG. 1 shows a context-sensitive language learning system and exemplary inputs thereto, according to an embodiment of an invention. In this illustrative embodiment, user 100 wears context-sensitive language learning system 110. This language learning system is able to incorporate contextual cues to both provide culturally-sensitive examples to the user and to adjust the pace of the instruction to account for the user's current attention level. As an example of the former, if the system detects that the user is riding a bicycle, it may choose to converse with the user regarding outdoor sports and activities. Furthermore, if the user is learning French and it is temporally appropriate, the system may ask the user questions about the Tour de France. On the other hand, the system may notice that the user is distracted (e.g. the user is engaging in another mentally taxing activity) and may therefore choose to ask fewer questions than it would otherwise. By combining increased awareness of the user's cultural milieu with sensitivity for the user's attention level, the system can better tailor its pedagogical methodology to facilitate more effective language acquisition.

The system contains user input devices 120, which may include, for example, speech/audio or point-and-click menus. The system also contains user output devices 130, such as speakers, headphones, and/or visual display. System 110 may acquire audio data 103, visual information 104, biometric data 105, global positioning system (GPS) data 107, and velocity data 108. This GPS data can be used to identify the user's location and allow the module to isolate a set of questions and conversation topics related to that specific area. For example, if a user is learning Italian and the module, using GPS, recognizes that the use is in a grocery store, the module may ask questions related to items in a grocery store in Italian. Additionally, velocity data 108, either alone or in conjunction with GPS data 107, can be used to determine whether the user is stationery, walking, running, or driving, and to thus determine an appropriate pace of questioning. For example, rapid questioning of a user who is operating a vehicle may distract the user and result in a dangerous situation.

The speech, audio, visual, and biometric recognition modules may be used to identify the user's surroundings to provide appropriate questions for the user. For example, if a camera identifies a dog and an audio recognition system recognizes a dog's bark, the system may prompt the user to answer questions about a dog. The system may also incorporate simple games based on the recognition systems that will improve the user's vocabulary. For example, “I Spy” is a popular game that involves the identification of objects of a certain shape or color. The system can isolate an object and then request the user to identify it through questions in a particular language.

The system may also be synchronized to the user's home computer 106 to update daily activities and to-do list in order to help the system adapt to the user's activities and pace of life. The system may also synchronize to, for example, a personal digital assistant (PDA) (e.g., Palm or Blackberry), mobile phone, smart watch, or any other electronic repository of scheduling information. Biometrics may also be used to measure the user's heart rate to determine if the user is doing exercise, nervous, or under strain. If, for example, if the user is traveling at a fast pace, the system may ask fewer questions so not to distract the user or ask questions related to the user's current activities. The system will be able to recognize activities based on the user's responses to a question “what are you doing?” or the module can sync with the user's planner and follow the user through their daily scheduled activities. If the user is moving slowly, the module may ask more questions and process more information related to the surroundings. Depending on the user's preference and their pace settings, the system may determine that it should refrain from interacting with the user.

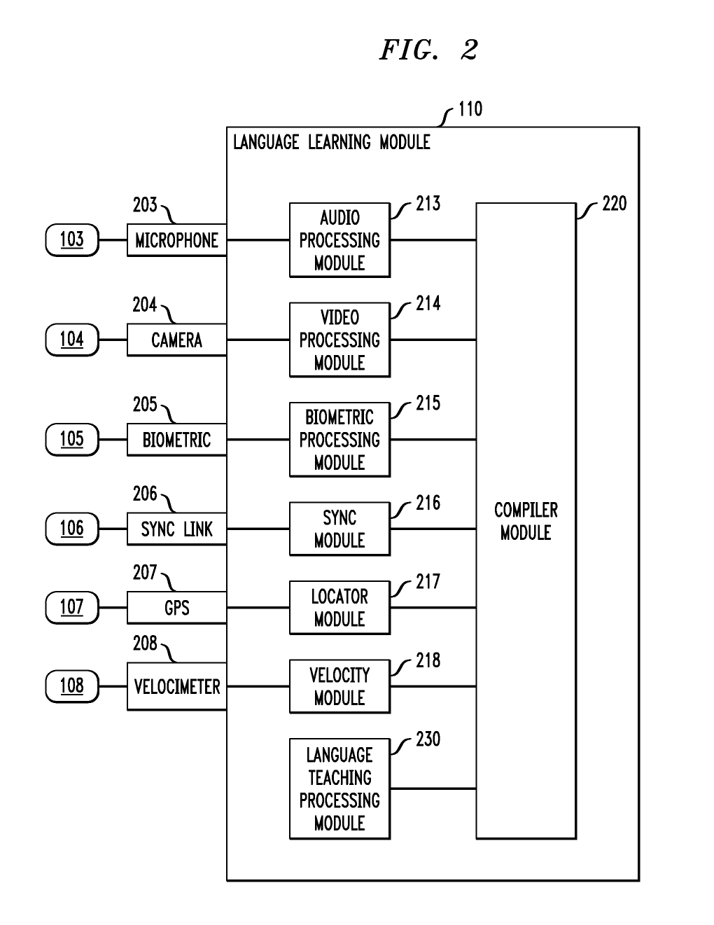

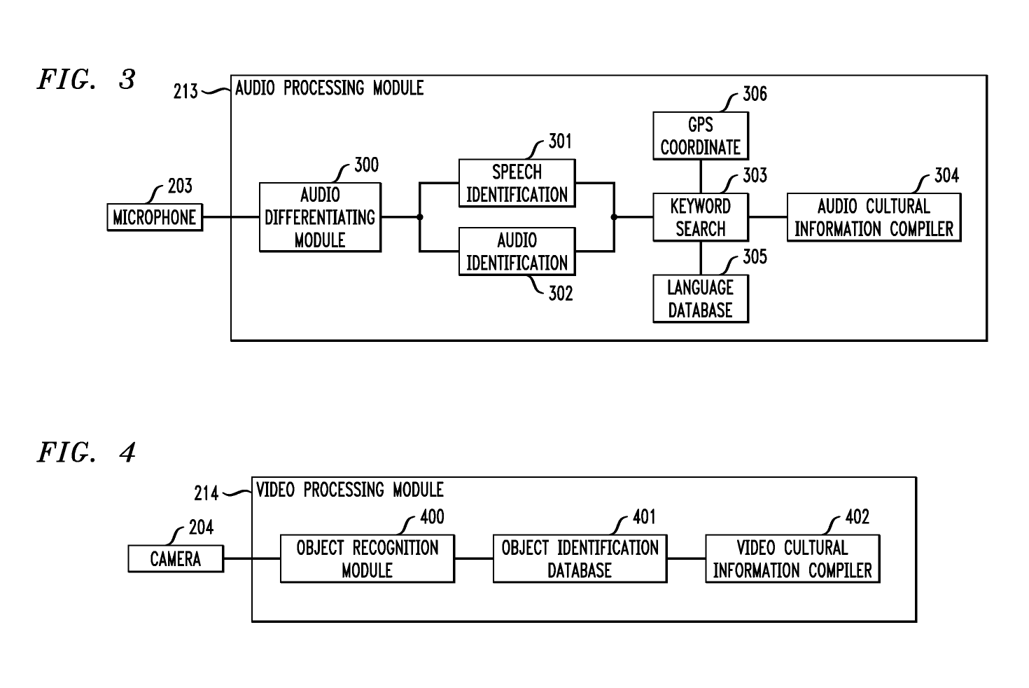

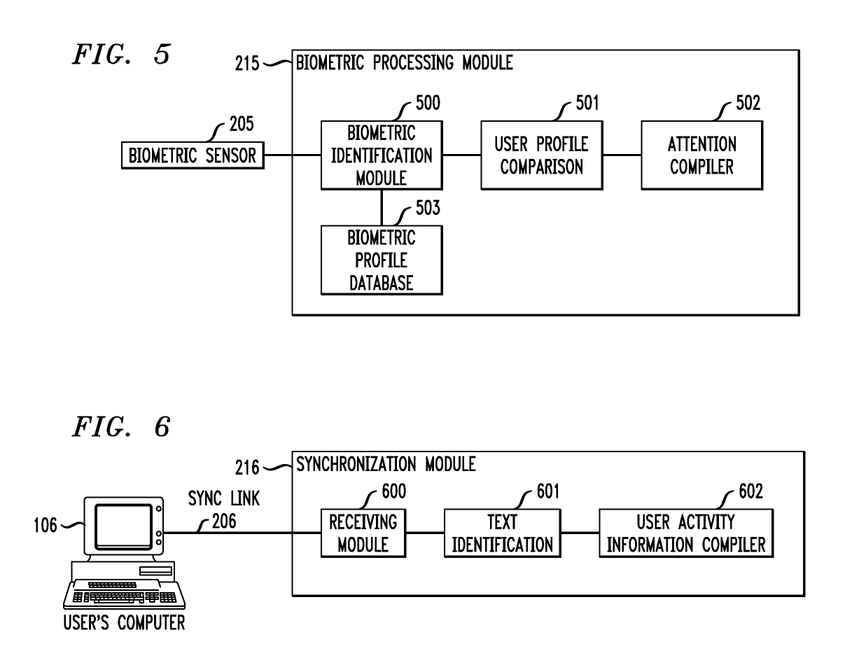

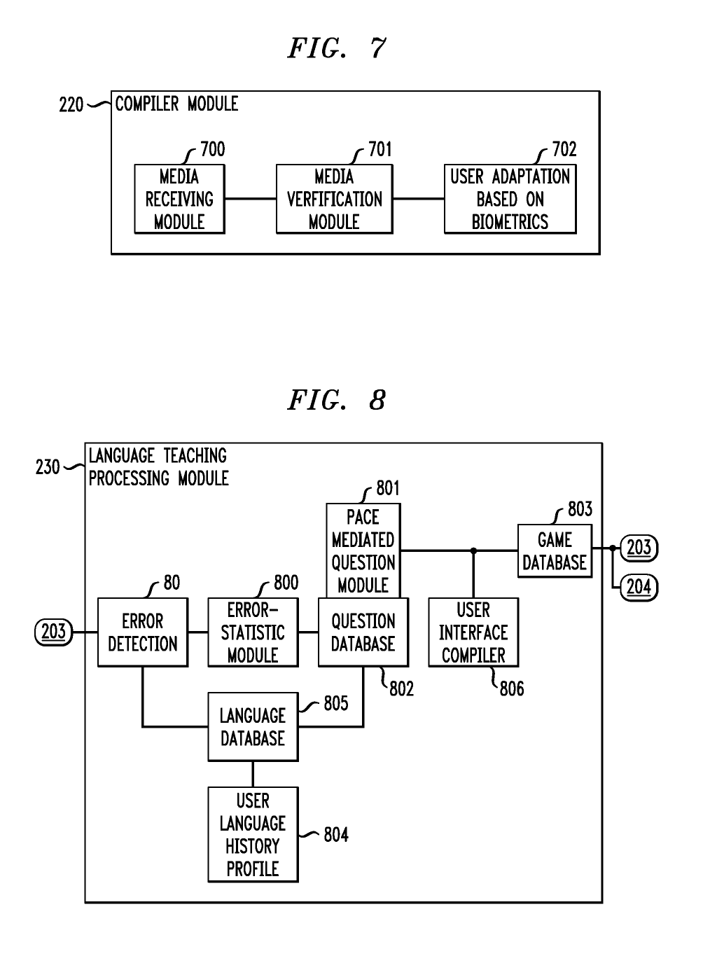

FIG. 2 shows another view of context-sensitive language learning system 110 which contains various inputs for data. Microphone 203 may provide audio data (103 on FIG. 1) for audio processing module 213, which is discussed in further detail in reference to FIG. 3 below. Camera 204 may provide visual data (104 on FIG. 1) for video processing module 214, which is discussed in further detail in reference to FIG. 4 below. Biometric sensor 205 may provide biometric data (105 on FIG. 1) to biometric processing module 215, which is discussed in further detail in reference to FIG. 5 below. This biometric data may include, for example, heart rate sensor, blood pressure, blinking frequency, perspiration, brainwave, eye movements, or any other data related to a user's attention level. Additionally, GPS sensor 207 may provide GPS data (107 on FIG. 1) to locator module 217 in order to determine the physical location of the user. Velocimeter 208 may provide velocity data (108 on FIG. 1) to velocity module 218 in order to determine the user's current movements. At least a portion of the information from the various sensors may be sent to compiler module 220, which is discussed in further detail in reference to FIG. 7 below. Language teaching processing module 230 may organize the data received from compiler module 220 in order to produce create teaching materials for the user, which is in a format compatible with the user input and output devices (120 and 130 in FIG. 1). This module will be discussed in further detail in reference to FIG. 8 below.

FIG. 3 shows an audio processing module, according to an embodiment of the invention. Audio processing module 213 receives audio data (103 in FIG. 1) from microphone 203. Audio differentiating module 300 sorts audio data for speech recognition 301 and identification of other audio 302 such as sounds, music, and background noise. Keyword search 303 identifies keywords stored in language database 305 that is linked with GPS coordinate 306 to allow audio cultural information compiler 304 to organize any relevant text, audio, or video samples based on the keywords.

For example, OPS coordinate 306 may indicate that the user is in a museum and the keyword search 303 may identify words such as “Picasso” and “Dali.” Accordingly, the system may choose to engage the user in conversation regarding 20th century Spanish art or merely ask the user what he thinks of the works he is viewing. By tailoring the conversation to the context, the system can provide more relevant and engaging exercises, which in turn will facilitate more effective learning.

FIG. 4 shows an exemplary video processing module, according to an embodiment of the invention. Video processing module 214 receives video data (104 in FIG. 1) from a camera 204. Object recognition module 400 identifies visible objects using object identification database 401. When an object is identified, video cultural information compiler 402 organizes information relevant to the image to present to the user.

For example, object recognition module 400, through the use of object identification database 401, may detect the presence of bats, helmets, and balls. Accordingly, video cultural information compiler 402 may conclude that the user is at a baseball game. Therefore, the system may initiate dialogue in the target language about what the user's favorite team or players are. If the user is keenly interested in baseball, learning words which are relevant to baseball may be more useful to the user than rote examples, which may cover subjects in which the user lacks interest and will therefore find irrelevant and uninteresting (and probably useless as well).

FIG. 5 shows an exemplary biometric processing module, according to an embodiment of the invention. Biometric processing module 215 receives biometric data (105 in FIG. 1) from biometric sensors 205. Biometric identification module 500 may compare current biometric data from stored user profile 501, comprising previous biometric data from the present user, as well as a repository of known biometric data stored in biometric profile database 503, to develop a biometric profile which may correlate to an emotional state, such as tired, alert, exercising, stressed, calm, etc. This comparison may be used by attention compiler 502 to adjust the pace of the language learning in response to a user's attention level.

For example, a user who is stressed or tired may be less able to engage in faster-paced learning then one who is calm and focused. If biometric data identification module 500 detects, for example, that the user's heartbeat is significantly faster than user profile 502 would indicate and biometric profile database 503 shows that this increased heart rate is likely to indicate that the user is stressed and distracted, attention compiler 502 may choose to decrease the pace of language learning or perhaps even pause until the user is calmer and better able to focus on his studies.

FIG. 6 shows a synchronization module, according to an embodiment of the invention. Synchronization module 216 links to the user's computer, PDA, mobile phone, or other electronic scheduler 106 by means of synchronization link 206, which may be any physical or logical connection (such as IEEE 1394 or USB) and receives information through receiving module 600. Text identification system 601 identifies the user's schedule and daily activities. The user activity information compiler sends data on the user's schedule to the main compiler module 203. For example, receiving module 600 may obtain a user's schedule and to-do list from a user's Blackberry 106 through a USB connection 206. Text identification system may indicate that the user is going to an opera that night and so it may ask the user questions about the opera or quiz the user on words likely to be encountered at that opera.

FIG. 7 shows an exemplary compiler module, according to an embodiment of the invention. Media receiving module 700 processes information from processing modules 213, 214, 215, 216 and 217. Media verification system 701 does a statistical analysis using the GPS data to verify that the object or audio identified by the module is indeed that particular object or audio. For example, if the user is somewhere very cold it is unlikely that they will encounter a palm tree, in which case the system would verify using GPS. However, if the user is somewhere cold but in a museum, it is possible they are looking at a palm tree. Compiler 220 then creates temporary profile 702 of the user based on their pace and attention in the user adaptation based on biometrics.

FIG. 8 shows an exemplary language teaching processing module, according to an embodiment of the invention. Language teaching processing module 230 is the hub where the language learning information is processed. This module permits the system to adapt to various levels of language comprehension and recognize the patterns of the user's language learning capabilities. The system can keep track and inform the user of the nature and frequency of their error. If the user struggles with particular language patterns, those patterns might be emphasized or avoided in questions asked or responses given by the system depending on the instructional strategy.

The temporary profile created by 702 is stored in user language history profile 804, which also contains the user's basic language history and comprehension information. Pace-mediated question module 801 selects questions based on the temporary profile of the user's current attention level from the question database 802, which lies within language database 805. The questions within the database are also compiled in a hierarchical system based on the results from error-statistic module 800, which indicates in which areas of the language the user has the highest number of errors. Error-statistic module 800 receives information on errors from error detection module 807, which detects errors in pronunciation and incorrect language use via microphone 203. User interface compiler prepares the information processed by language teaching processing module 230 and also prepares games to executed from the game database 803 which is connected to microphone 203 and video camera 204.

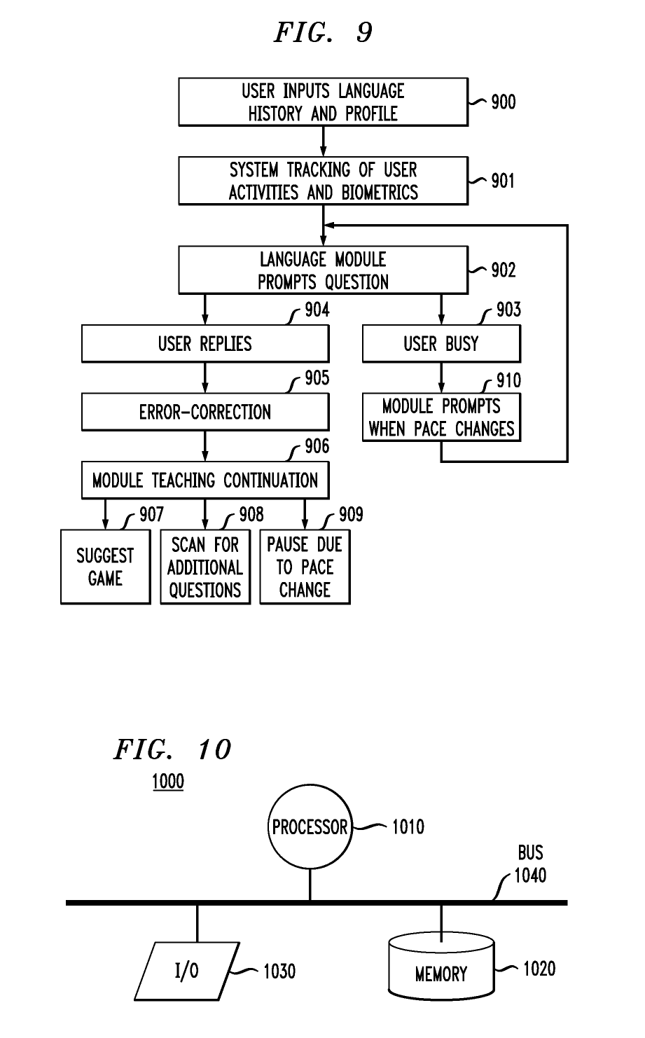

FIG. 9 is an exemplary method for context-sensitive language learning, according to an embodiment of the invention. This exemplary method begins with the user inputting his or her language history and language profile (step 900). Next, the system tracks the user's activities and biometrics (step 901). The system then prompts the user with a question (step 902). If the user does not reply or is busy (step 903), the system prompts the user when his or her pace slows or increased attention is otherwise indicated, e.g., through biometrics (step 910). If the user replies (step 904), this reply is verified with an error correction system (step 905) and the system continues teaching through a series of exercises (step 906). The system may suggest a game (step 907), scan for and ask the user additional questions (step 908), or pause due to a change in the user's pace or attention (step 909).

The methodologies of embodiments of the invention may be particularly well-suited for use in an electronic device or alternative system. For example, FIG. 10 is a block diagram depicting an exemplary processing system 1000 formed in accordance with an aspect of the invention. System 1000 may include a processor 1010, memory 1020 coupled to the processor (e.g., via a bus 1030 or alternative connection means), as well as input/output (I/O) circuitry 1040 operative to interface with the processor. The processor 1010 may be configured to perform at least a portion of the methodologies of the present invention, illustrative embodiments of which are shown in the above figures and described therein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 1010. In any case, it is to be appreciated that at least a portion of the components shown in the above figures may be implemented in various forms of hardware, software, or combinations thereof, e.g., one or more DSPs with associated memory, application-specific integrated circuit(s), functional circuitry, one or more operatively programmed general purpose digital computers with associated memory, etc. Given the teachings of the invention provided herein, one of ordinary skill in the art will be able to contemplate other implementations of the components of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A language learning system comprising:
at least one interface for communicating with at least one user;
at least one sensor for collecting at least one form of data regarding a context in which the system is being used; and
a processing device coupled to the at least one interface and the at least one sensor, operative to make at least one adjustment to the communication with the user based on analysis of at least a portion of the data collected by the at least one sensor.

2. The language learning system of claim 1, wherein the at least one form of data is selected from a group comprising audio data, visual information, biometric data, location, and velocity.

3. The language learning system of claim 1, wherein the at least one sensor is selected from a group comprising a microphone, a camera, a biometric sensor, a global positioning system (GPS) device, and a velocimeter.

4. The language learning system of claim 1, wherein the processing device is further operative to determine the attention level of the user based on at least a portion of the data collected by the at least one sensor and making at least one corresponding adjustment to the communication with the at least one user.

5. The language learning system of claim 1, wherein the processing device is further operative to store at least one profile, comprised of at least a portion of the data collected by the at least one sensor.

6. The language learning system of claim 5, wherein the processing device is further operative to:
detect changes between at least a portion of the current data and at least a portion of the at least one stored profile; and
make at least one corresponding adjustment to the communication with the at least one user.

7. The language learning system of claim 1, further comprising a module operative to acquire data from at least one external data repository.

8. The language learning system of claim 7, wherein the repository is selected from a group comprising a computer, a personal digital assistant, a mobile telephone, and a smart watch.

9. The language learning system of claim 7, wherein the module is further operative to making at least one corresponding adjustment to the communication with the at least one user.

10. The language learning system of claim 1, wherein the module is further operative to tracking at least one of the nature and frequency at least a portion of at least one error made by the user.

11. The language learning system of claim 10, wherein the module is further operative to making at least one corresponding adjustment to the communication with the at least one user.

12. A method for facilitating language acquisition, the method comprising the steps of:
collecting at least one form of data regarding the context in which the method is being used; and
communicating with at least one user;
wherein the communication is based at least in part on analysis of at least a portion of the data collected by at least one sensor.

13. The method of claim 12, wherein the at least one form of data is selected from a group comprising audio data, visual information, biometric data, and location-based data.

14. The method of claim 12, further comprising the step of determining the attention level of the user based on at least a portion of the data collected by the at least one sensor and making at least one corresponding adjustment to the communication with the at least one user.

15. The method of claim 14, further comprising the step of storing at least one profile, comprised of at least a portion of the data collected by the at least one sensor.

16. The method of claim 15, further comprising the steps of:
detecting changes between at least a portion of the current data and at least a portion of the at least one stored profile; and
making at least one corresponding adjustment to the communication with the at least one user.

17. The method of claim 16, further comprising the step of acquiring data from at least one external data repository.

18. The method of claim 17, wherein the repository is selected from a group comprising a computer, a personal digital assistant, a mobile telephone, and a smart watch.

19. The method of claim 12, wherein the module is further operative to tracking at least one of the nature and frequency at least a portion of at least one error made by the user.

20. An article of manufacture for facilitating language acquisition, the article comprising a machine readable storage medium containing one or more programs which when executed implement the steps of:
collecting at least one form of data regarding the context in which the article is being used; and
communicating with at least one user;
wherein the communication is based at least in part on analysis of at least a portion of the data collected by at least one sensor.

21. The article of claim 20, wherein the at least one form of data is selected from a group comprising audio data, visual information, biometric data, location, and velocity.
